(19) United States
(12) Patent Application Publication
(10) Pub. No.: US 2024/0109980 A1
(43) Pub. Date: Apr. 4, 2024

(54) RESIN-EXTENDED MODIFIED DIENE RUBBER

(71) Applicant: COMPAGNIE GENERALE DES ETABLISSEMENTS MICHELIN, Clermont-Ferrand (FR)

(72) Inventors: FLORENT VAULTIER, Clermont-Ferrand (FR); KEVIN ROOS, Clermont-Ferrand (FR); FABIEN BARRET, Clermont-Ferrand (FR)

(21) Appl. No.: 18/274,745

(22) PCT Filed: Jan. 14, 2022
(86) PCT No.: PCT/FR2022/050080

§ 371 Date: Jul. 28, 2023

(30) Foreign Application Priority Data
Jan. 29, 2021 (FR) FR2100886

(51) Int. Cl. C08C 19/22; B60C 1/00; B60C 11/00; C08C 19/25; C08L 9/06

(52) U.S. Cl. CPC C08C 19/22; B60C 1/0016; B60C 11/0008; C08C 19/25; C08L 9/06; B60C 2011/0025

(57) ABSTRACT

A resin-extended modified diene elastomer is capable of being obtained by a process comprising at least: anionically polymerizing, in an organic solvent, at least one conjugated diene monomer having from 4 to 12 carbon atoms in the presence of a polymerization initiator to form a living diene elastomer having a number-average molar mass Mn1; modifying the living diene elastomer by reaction with a modifying agent to form a modified diene elastomer having a number-average molar mass Mn2 and a glass transition temperature, measured according to the standard ASTM D3418-08, within a range extending from −95° C. to −70° C.; adding at least one plasticizing resin to the organic solvent comprising the modified diene elastomer; and removing the organic solvent to obtain the resin-extended modified diene elastomer. The resin-extended modified diene elastomer has an Mn2/Mn1 ratio of strictly greater than 1.00 and an Mn2 of greater than or equal to 200,000 g/mol.

The invention relates to a resin-extended modified diene elastomer, to the process for manufacturing same and to rubber compositions containing same, these rubber compositions being intended in particular for the manufacture of semi-finished articles for tyres and for the manufacture of tyres.

Now that savings in fuel and the need to protect the environment have become a priority, it is desirable to produce mixtures having a hysteresis which is as low as possible in order to be able to process them in the form of rubber compositions which can be used in the manufacture of various semi-finished products participating in the manufacture of tyres, such as, for example, underlayers, sidewalls or treads, and in order to obtain tyres having a reduced rolling resistance.

Ideally, for example, a tyre tread must fulfil a great many technical requirements, which are often contradictory in nature, including good dry and wet grip while affording low rolling resistance.

One means to achieve this performance compromise is to use high-molecular-weight diene elastomers, such as for example oil-extended elastomers. However, these high-molecular-weight diene elastomers have high viscosities, and are difficult to extrude, even when an extender oil is added to them. Non-homogeneous extrusion produces poor-quality extrudates which do not meet the dimensional tolerances required by the factory processes for the manufacture of semi-finished articles for tyres. To remedy this problem, it is possible to reduce the viscosity of these oil-extended elastomers by prolonging the mixing time, in particular before extrusion. However, these actions are undesirable because they can cause degradation of these elastomers and hence degrade the mechanical properties of the resulting crosslinked rubber compositions. In addition, an increase in the mixing time incurs cost in the industrial manufacturing process.

Another means for achieving the performance compromise of dry and wet grip while affording low rolling resistance consists in using a high content of plasticizing resins in the low-hysteresis rubber compositions. However, this use of a high content of plasticizing resins has the consequence of increasing the tackiness of the composition. This increase in the tackiness of the composition is detrimental to the processability of the rubber composition in the various mixing devices.

To overcome this drawback, the Applicant has developed resin-extended diene elastomers. Such diene elastomers are described in application WO2019/020948.

Continuing its research, the Applicant sought to further improve the processability of the resin-extended diene elastomers by yet further reducing the tackiness of the rubber compositions containing them without degrading the other properties of these compositions.

The aim of the present invention is therefore to provide resin-extended diene elastomers which make it possible to obtain rubber compositions having an improved rolling resistance/processability performance compromise. The improvement of this compromise should also not come at the expense of the quality of the extrudate.

This aim is achieved by specific resin-extended diene elastomers and by rubber compositions containing them. More precisely, this object is achieved via the selection of a resin-extended modified diene elastomer capable of being obtained by a process comprising at least:
a step of anionically polymerizing, in an organic solvent, at least one conjugated diene monomer having from 4 to 12 carbon atoms in the presence of a polymerization initiator to form a living diene elastomer having a number-average molar mass Mn1 measured by triple detection size exclusion chromatography;
a step of modifying the living diene elastomer of number-average molar mass Mn1, in the organic solvent, by reaction with a modifying agent to form a modified diene elastomer having a number-average molar mass Mn2 measured by triple detection size exclusion chromatography and a glass transition temperature measured according to the standard ASTM D3418-08 within a range extending from −95° C. to −70° C.;
a step of adding at least one plasticizing resin to the organic solvent comprising the modified diene elastomer;
a step of removing the organic solvent to obtain the resin-extended modified diene elastomer;
   the resin-extended modified diene elastomer having an Mn2/Mn1 ratio of strictly greater than 1.00 and an Mn2 of greater than or equal to 200 000 g/mol.

This resin-extended modified diene elastomer as defined above advantageously confers on the rubber compositions containing it a significantly reduced tackiness compared to the resin-extended diene elastomers of the prior art (and thus an improved processability) while retaining good hysteresis properties.

In addition, the resin-extended modified diene elastomer as defined above has the advantage of providing a rubber composition of homogeneous and uniform quality, which is reflected during extrusion thereof by a good finish of the extrudate, both at the level of its surface and of its edges.

Another subject of the present invention relates to a rubber composition based on at least one resin-extended modified diene elastomer as defined above, at least one reinforcing filler and at least one crosslinking system. These compositions have the following advantages: they experience little to no adhesion to mixing devices and other tools for manufacturing compositions and semi-finished articles for tyres; they have good hysteresis properties; and the extrusion thereof is reproducible and homogeneous.

Another subject of the present invention relates to a semi-finished rubber article for a tyre comprising at least one crosslinkable or crosslinked rubber composition as defined above. Preferably, the semi-finished article for a tyre is a tread.

Another subject of the present invention is a tyre comprising at least one rubber composition as defined above or a semi-finished article defined above.

Measurements and Tests Used

Measurement of the Mn, Mw and PDI of the Elastomers by Triple Detection Size Exclusion Chromatography (SEC-3D)

The number-average molar mass (Mn), and where appropriate the weight-average molar mass (Mw) and the polydispersity index (PDI) of the elastomers are determined in an absolute manner, by triple detection size exclusion chromatography “SEC-3D” (SEC: Size Exclusion Chromatography).

Triple detection size exclusion chromatography has the advantage of measuring average molar masses directly without calibration.

The refractive index increment dn/dc of the sample is first determined. For this, the sample is dissolved beforehand in tetrahydrofuran at different precisely known concentrations (0.5 g/l, 0.7 g/l, 0.8 g/l, 1 g/l and 1.5 g/l) and then each solution is filtered through a filter with a porosity of 0.45 μm. Each solution is subsequently directly injected, using a syringe driver, into a Wyatt differential refractometer of Optilab T-Rex trade name of wavelength 658 nm and thermostatically controlled at 35° C. The refractive index is measured by the refractometer at each concentration. The Astra software from Wyatt produces a straight line of the signal of the detector as a function of the concentration of the sample. The Astra software automatically determines the slope of the straight line corresponding to the refractive index increment of the sample in the tetrahydrofuran at 35° C. and at the wavelength of 658 nm.

In order to determine the average molar masses, use is made of the 1 g/l solution previously prepared and filtered, which is injected into the chromatographic system. The apparatus used is a Waters Alliance chromatographic line. The elution solvent is tetrahydrofuran protected from oxidation with 250 ppm of BHT (2,6-di(tert-butyl)-4-hydroxytoluene), the flow rate is 1 ml·min⁻¹, the temperature of the system is 35° C. and the analytical time is 60 min. The columns used are a set of three Agilent columns of PL Gel Mixed B LS trade name. The volume of the sample solution injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

For the calculation of the number-average molar masses and the polydispersity index, the value of the refractive index increment dn/dc of the solution of the sample obtained above is integrated. The software for processing the chromatographic data is the Astra system from Wyatt.

Measurement of the Mn, Mw and PDI of the Plasticizing Polymers by Refractive Index Size Exclusion Chromatography (SEC-RI)

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a plasticizing polymer (oil or resin). The various number-average molar masses (Mn) and weight-average molar masses (Mw) can be determined from commercial standards and the polydispersity index (PDI=Mw/Mn) can be calculated via a “Moore” calibration.

There is no specific treatment of the plasticizing polymer sample before analysis.

The latter is simply dissolved in the elution solvent at a concentration of approximately 1 g·l⁻¹. The solution is then filtered through a filter with a porosity of 0.45 μm before injection.

The apparatus used is a Waters Alliance chromatographic line. The elution solvent is either tetrahydrofuran protected from oxidation with 250 ppm of BHT (butylated hydroxytoluene), or tetrahydrofuran without antioxidant, the flow rate is 1 ml·min⁻¹, the temperature of the system is 35° C. and the analytical time is 45 min. The columns used are either a set of three Agilent columns of Polypore trade name or a set of four Agilent columns, two of PL Gel Mixed D trade name and two of PL Gel Mixed E trade name. The volume of the solution of the plasticizing polymer sample injected is 100 μl. The detector is a Waters 2410 differential refractometer and the software for processing the chromatographic data is the Waters Empower system. The calculated average molar masses are relative to a calibration curve produced with polystyrene standards.

Differential Calorimetry

The glass transition temperatures (Tg) of the elastomers, of the resins and of the plasticizing oils are determined using a differential scanning calorimeter according to the standard ASTM D3418-08 (2008).

Near-Infrared (NIR) Spectroscopy

The microstructure of the elastomers is characterized by the near-infrared (NIR) spectroscopy technique.

Near-infrared (NIR) spectroscopy is used to quantitatively determine the content by mass of styrene in the elastomer and also its microstructure (relative distribution of the 1,2-, trans-1,4- and cis-1,4-butadiene units). The principle of the method is based on the Beer-Lambert law generalized for a multicomponent system. As the method is indirect, it involves a multivariate calibration [Vilmin, F., Dussap, C. and Coste, N., Applied Spectroscopy, 2006, 60, 619-29] carried out using standard elastomers having a composition determined by ¹³C NMR. The styrene content and the microstructure are then calculated from the NIR spectrum of an elastomer film approximately 730 μm in thickness. The spectrum is acquired in transmission mode between 4000 and 6200 cm⁻¹ with a resolution of 2 cm⁻¹ using a Bruker Tensor 37 Fourier-transform near-infrared spectrometer equipped with an InGaAs detector cooled by the Peltier effect.

Inherent Viscosity

The inherent viscosity of the elastomers at 25° C. is determined from a 0.1 g·dl⁻¹ solution of elastomer in toluene, according to the following principle:

The inherent viscosity is determined by the measurement of the flow time t of the polymer solution and of the flow time tₒ of the toluene in a capillary tube.

The flow time of the toluene and the flow time of the 0.1 g·dl⁻¹ polymer solution are measured in an Ubbelohde tube (diameter of the capillary 0.46 mm, capacity from 18 to 22 ml) placed in a bath thermostatically controlled at 25° C.±0.1° C.

The inherent viscosity is obtained by the following relationship:

$${η}_{inh} = \frac{1}{C} ln [ \frac{( t )}{( {t}_{o} )} ]$$

where:
C: concentration of the solution of polymer in toluene in g·dl⁻¹,
t: flow time of the solution of polymer in toluene in seconds,
tₒ: flow time of the toluene in seconds,
ηᵢₙₕ: inherent viscosity expressed in dl·g⁻¹.

Dynamic Properties

The dynamic properties and in particular tan δ max are measured on a viscosity analyser (Metravib VA4000) according to the standard ASTM D 5992-96. The response is recorded of a sample of vulcanized composition (cylindrical test specimen with a thickness of 2 mm and a cross section of 79 mm²), subjected to a simple alternating sinusoidal shear stress, at a frequency of 10 Hz, under standard temperature conditions (23° C.) according to the standard ASTM D 1349-99. A strain amplitude sweep is carried out from 0.1% to 50% peak-to-peak (outward cycle) and then from 50% to 0.1% peak-to-peak (return cycle). The result more particularly made use of is the loss factor tan 6. For the return cycle, the maximum value of tan 6 observed, denoted tan 6 max, is indicated. This value is representative of the hysteresis of the material and in the present case of the rolling resistance: the smaller the value of tan 6 max, the lower the rolling resistance. In the examples, the results of the dynamic properties are given in base 100. An index of less than 100 will indicate an improvement in the hysteresis properties, and thus an improvement in the rolling resistance performance of a tyre.

Measurement of the Tack of the Compositions

The tack of the rubber compositions is measured by means of a tack measurement, which is also referred to as an adhesion test, also known as a probe-tack or micro-tack test. This test corresponds to a test of contact between a surface (a probe) and an adhesive (the composition).

The test is performed at a temperature of 70° C. corresponding to the temperature of the rubber composition and of the surface; the composition not being vulcanized. The variation in the force applied as a function of the movement is recorded. The test is carried out in accordance with the requirements of the standard ASTM D2979-01 (2009) under the following conditions:
Contact surface: EN-GJS-450 cast iron of average roughness Ra=0.4 microns machined by turning
Test temperature: 70° C.
Pressure and contact time: 50 N for 1 second (N=newton)

The tack index is calculated in base 100 with respect to the control with the peeling energy at 70° C. In this way, a result of less than 100 indicates a decrease in tackiness which corroborates a better processability of the composition.

Measuring the Garvey Rating of the Extruded Compositions

The determination of the Garvey rating representing the extrudability of the raw (that is to say non-vulcanized) compositions is performed in accordance with the standard ASTM D2230-96 (2002).

The appearance of the extrudate is rated according to the B system, namely a surface rating ranging from E to A, the letter E being the worst rating, and an edge rating ranging from 1 to 10 in ascending order, the number 1 being the lowest rating.

Determination of the amount of plasticizing resin in the resin-extended elastomer.

The determination of the amount of plasticizing resin in the resin-extended elastomer is also performed by refractive index size exclusion chromatography (SEC-RI) analysis.

There is no specific treatment of the resin-extended elastomer sample before analysis. It is simply dissolved to a concentration of about 1 g/l, in tetrahydrofuran with the antioxidant BHT at 250 ppm. The solution is then filtered through a filter with a porosity of 0.45 μm before injection.

The apparatus used is a Waters Alliance 2695 chromatograph. The elution solvent is tetrahydrofuran with the antioxidant BHT at 250 ppm. The flow rate is 1 ml/min, the temperature of the system is 35° C. and the analysis time is 35 min.

Use is made of a set of 3 Agilent columns in series, of PL Gel Mixed-D and PL Gel Mixed-E trade names. This set is composed of 2 Agilent PL Gel Mixed D columns and one Agilent PL Gel Mixed E column in series.

The volume of the solution of the resin-extended elastomer sample injected is 100 μl.

The detector is a Waters 2410 differential refractometer, of wavelength 810 nm, and the software for processing the chromatographic data is the Waters Empower system.

Calibrants using a non-resin-extended elastomer of the same microstructure as the resin-extended elastomer are used. These calibrants are prepared in tetrahydrofuran with the antioxidant BHT at 250 ppm (BHT butylated hydroxytoluene). Several calibrants are prepared from a non-resin-extended elastomer at precisely known concentrations in g/l so as to obtain a calibration range. Each calibrant is injected to 100 μl into the chromatographic system. With the aid of the data reprocessing software, each calibrant peak is integrated. It is then possible to determine the total area of the peak of each calibrant. A calibration straight line is then constructed by plotting the area of the peak of the calibrant as a function of the concentration.

The resin-extended elastomer is then injected following the creation of the calibration straight line. Since the signals for the resin and the elastomer are separated by means of the SEC columns, a quantification can thus be performed. The peak obtained for the elastomer is then integrated using the data reprocessing software; the area for said peak is then reported on the previously constructed calibration straight line. It is then possible to deduce the elastomer concentration in g/L in the resin-extended elastomer (Cₑₗₐₛₜₒ). The concentration of the dissolved resin-extended elastomer is known (Cₛₐₘₚ). Quantification of the resin content is thus performed indirectly via the following relationship:

Resin content=1−Cₑₗₐₛₜₒ/Cₛₐₘₚ

### DETAILED DESCRIPTION OF THE INVENTION

In the present description, unless expressly indicated otherwise, all the percentages (%) shown are percentages (%) by mass.

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

For the purposes of the present invention, the expression “part by weight per hundred parts by weight of elastomer” (or phr) should be understood as meaning the part by mass per hundred parts by mass of elastomer.

In the present description, the term “predominantly” or “predominant”, in connection with a compound, means that this compound is predominant among the compounds of the same type in the composition, i.e. that it is the one which represents the largest amount by mass among the compounds of the same type. In the same way, a “predominant” species in a modified elastomer is that representing the largest fraction by weight among the species constituting the modified diene elastomer, relative to the total weight of the modified diene elastomer. In a system comprising just one compound of a certain type, the latter is predominant for the purposes of the present invention. Preferably, the term predominant is understood to mean a compound present at more than 50%, more preferentially still a compound present at more than 60% by weight.

In the present description, when no further information is given, primary or secondary amine is understood to mean a primary or secondary amine which is or is not protected by a protective group known to a person skilled in the art.

In the present description, modified diene elastomer is understood to mean a mixture of macromolecules resulting from the reaction of a living diene elastomer with a modifying agent comprising at least two functions which are reactive with respect to the reactive end of the living diene elastomer.

A person skilled in the art will understand that a modification reaction with a modifying agent comprising more than one function reactive with respect to the living elastomer results in a mixture of macromolecules modified at the chain ends and of macromolecules coupled or star-branched to at least three branches and at most as many branches as reactive functions borne by the modifying agent; the coupled and star-branched forms constituting the branched chains of the modified elastomer. Depending on the operating conditions, mainly the molar ratio of the modifying agent to the living chains, and the number of its reactive functions, certain species are more or less present, indeed even predominant, in the mixture.

In the present description, the expression “monomer unit”, whether it be diene or other, is understood to be a repeat unit of the polymer resulting from the monomer in question.

In the present description, the expression “branching unit” is understood as a non-repeating unit (there is just one of them in the polymer), resulting from the modifying agent with which the living diene elastomer chains has or have reacted and to which the diene elastomer chains are attached. The branching unit may consist, for example, of an atom to which the diene elastomer chains are attached, it being possible for this atom to be unsubstituted or substituted by chemical functions and/or groups.

The compounds mentioned in the description may be of fossil origin or may be biobased. In the latter case, they may be partially or completely derived from biomass or may be obtained from renewable starting materials derived from biomass. Similarly, the compounds mentioned may also originate from the recycling of already-used materials, i.e. they may be partially or totally derived from a recycling process, or obtained from starting materials which are themselves derived from a recycling process. Polymers, plasticizers, fillers, etc. are concerned in particular.

For the purposes of the present invention, the term “resin-extended elastomer” is understood to mean a solid material of composite type formed from an elastomer and a resin which are intimately mixed with one another; the mixing of the resin with the elastomer being carried out in a liquid medium in an organic solvent, preferably in a non-polar organic solvent. The mixing of the resin is therefore carried out in an elastomer in solution; that is to say the organic solvent and said elastomer form just a single phase visible to the naked eye. There is no precipitate or suspension of particles of said elastomer in the solution. This definition therefore excludes materials which would have been obtained by bulk mixing (or dry-mixing) an elastomer with a resin. Given that the two constituents of this material are intimately mixed with one another in liquid phase, a single Tg value is obtained when this parameter is measured for the resin-extended elastomer. This Tg of the resin-extended elastomer is different from that of the synthetic elastomer and from that of the plasticizing resin measured before they are mixed.

A first subject of the present invention relates to a resin-extended modified diene elastomer capable of being obtained by a process comprising at least:
a step of anionically polymerizing, in an organic solvent, at least one conjugated diene monomer having from 4 to 12 carbon atoms in the presence of a polymerization initiator to form a living diene elastomer having a number-average molar mass Mn1 measured by triple detection size exclusion chromatography;
a step of modifying the living diene elastomer of number-average molar mass Mn1, in the organic solvent, by reaction with a modifying agent to form a modified diene elastomer having a number-average molar mass Mn2 measured by triple detection size exclusion chromatography and a glass transition temperature, measured according to the standard ASTM D3418-08, within a range extending from −95° C. to −70° C.;
a step of adding at least one plasticizing resin to the organic solvent comprising the modified diene elastomer;
a step of removing the organic solvent to obtain the resin-extended modified diene elastomer;
   the resin-extended modified diene elastomer having an Mn2/Mn1 ratio of strictly greater than 1.00 and an Mn2 of greater than or equal to 200 000 g/mol.

The resin-extended modified diene elastomer based on a plasticizing resin and a diene elastomer according to the invention comprises at least one modified diene elastomer and at least one plasticizing resin. This resin-extended modified diene elastomer can also contain other extenders such as, for example, extender oils, in particular extender oils of petroleum or natural origin, such as, for example, oils comprising triglycerides. When the resin-extended modified diene elastomer also comprises an extender oil, the content of the latter is preferentially lower than the content of the resin in the modified diene elastomer. Preferentially, the resin-extended modified diene elastomer according to the invention consists, preferentially essentially, of a modified diene elastomer as defined below and at least one plasticizing resin; that is to say it does not comprise any extender oil.

The resin-extended diene elastomer which can be used in the context of the present invention has the following characteristics: it comprises within its structure a branching unit and at least two diene elastomer branches obtained by anionic polymerization of at least one conjugated diene monomer having from 4 to 12 carbon atoms, the plasticizing resin is intimately mixed into the modified diene elastomer, it has a number-average molar mass Mn1 measured before the modification step by triple detection size exclusion chromatography, it has a number-average molar mass Mn2 measured after the modification step by triple detection size exclusion chromatography of greater than or equal to 200 000 g/mol and an Mn2/Mn1 ratio of strictly greater than 1.00, it has a glass transition temperature measured according to the standard ASTM D3418-08 and before its extension with the resin of within a range extending from −95° C. to −70° C. By virtue of these characteristics, this resin-extended modified diene elastomer makes it possible to obtain rubber compositions which surprisingly have an improved rolling resistance/processability compromise without degrading the quality of the extrudate thereof.

Those skilled in the art will readily understand that when the Mn2/Mn1 ratio of a diene elastomer is equal to 1.00, this diene elastomer is not modified within the meaning of the present invention; that is to say that it is predominantly, or preferentially exclusively, linear. It may however be functionalized at the chain end or at the chain extremity, but this functionalization is not a branching unit for the purposes of the present invention.

Preferentially, the Mn2/Mn1 ratio is greater than or equal to 1.10, more preferentially greater than or equal to 1.20; and preferably is within a range extending from 1.30 to 4.00; more preferentially within a range extending from 1.40 to 2.00.

Preferentially, the number-average molar mass Mn1 is greater than or equal to 140 000 g/mol, preferably is within a range extending from 150 000 g/mol to 200 000 g/mol, and the resin-extended modified diene elastomer has an Mn2/Mn1 ratio of strictly greater than 1.00, more preferentially extending within a range of from 1.30 to 4.00, more preferentially still in a range extending from 1.40 to 2.00.

Preferentially, the resin-extended modified diene elastomer according to the invention has a number-average molar mass Mn2 of greater than or equal to 220 000 g/mol, more preferentially greater than or equal to 230 000 g/mol, more preferentially still greater than or equal to 250 000 g/mol.

More preferentially still, the resin-extended modified diene elastomer according to the invention has a number-average molar mass Mn2 of greater than or equal to 220 000 g/mol, more preferentially greater than or equal to 230 000 g/mol, more preferentially still greater than or equal to 250 000 g/mol and an Mn2/Mn1 ratio of greater than or equal to 1.10, more preferentially greater than or equal to 1.20; preferably within a range extending from 1.30 to 4.00; more preferentially in a range extending from 1.40 to 2.00.

Elastomer capable of being used within the context of the invention should be understood in a known way as meaning a synthetic elastomer consisting at least in part of conjugated or non-conjugated diene monomer units.

Synthetic diene elastomer is understood more particularly to mean:
any homopolymer of a diene monomer, particularly a conjugated diene monomer, in particular any homopolymer obtained by polymerization of a conjugated diene monomer having from 4 to 12 carbon atoms;
any copolymer obtained by copolymerization of one or more diene monomers with one another or with one or more vinylaromatic monomers.

In the case of copolymers with one or more vinylaromatic monomers, the latter can contain from 85.0% to 99.9% by weight of conjugated diene units and from 0.1% to 15.0% by weight of units resulting from vinylaromatic monomers.

The resin-extended modified diene elastomer is obtained from a process, preferably a continuous process, comprising at least one step of anionic polymerization in an organic solvent.

The polymerization step is carried out conventionally by anionic polymerization initiated, for example, by means of an organic compound of an alkali metal or alkaline earth metal. The anionic polymerization generates elastomer chains having a reactive site at the chain end. The term then commonly used is living elastomer or living chain.

In the context of an anionic polymerization, the polymerization initiator can be any known anionic initiator. An initiator containing an alkali metal, such as lithium, or an alkaline earth metal, such as barium, is preferably used. Suitable as lithium-containing initiators in particular are those comprising a carbon-lithium bond or a nitrogen-lithium bond. Representative compounds are aliphatic organolithium compounds, such as ethyllithium, n-butyllithium (n-BuLi) or isobutyllithium, and lithium amides obtained from a cyclic secondary amine, such as pyrrolidone and hexamethyleneimine. Such anionic polymerization initiators are known to those skilled in the art. Preferably, the polymerization initiator can be n-butyllithium.

The polymerization can be carried out in a way known per se, continuously or batchwise, and preferably continuously. The polymerization is generally carried out at temperatures of between 0° C. and 110° C. and preferably from 40° C. to 100° C., indeed even from 50° C. to 90° C. The polymerization process is carried out in solution, in a more or less concentrated or dilute medium.

The organic polymerization solvent is preferably an inert hydrocarbon solvent which can, for example, be an aliphatic or alicyclic hydrocarbon, such as pentane, hexane, heptane, isooctane, cyclohexane, cyclopentane or methylcyclohexane, or an aromatic hydrocarbon, such as benzene, toluene or xylene.

Preferentially, the anionic polymerization step can also be carried out in the presence of at least one vinylaromatic monomer having from 8 to 20 carbon atoms.

The following, for example, are suitable as vinylaromatic monomers: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene, and a mixture of these monomers. Preferably, the vinylaromatic monomer is styrene.

The following are suitable in particular as conjugated diene monomers having from 4 to 12 carbon atoms: 1,3-butadiene, 2-methyl-1,3-butadiene (isoprene), 2,3-di(C1-C5 alkyl)-1,3-butadienes such as for example 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene, 2,4-hexadiene and mixtures of these monomers. Preferably, the conjugated diene monomer having from 4 to 12 carbon atoms is 1,3-butadiene or 2-methyl-1,3-butadiene, and more preferentially is 1,3-butadiene.

Thus, depending on the monomers selected, the modified diene elastomer can be selected from the group consisting of polybutadienes, synthetic polyisoprenes, butadiene copolymers, isoprene copolymers and the mixtures of these elastomers.

Preferentially, the modified diene elastomer is selected from the group consisting of polybutadienes, synthetic polyisoprenes, copolymers of butadiene and styrene (SBRs), copolymers of isoprene and styrene (SIRs), copolymers of isoprene and butadiene (BIRs), and isoprene/butadiene/styrene copolymers (SBIRs).

Preferentially, a 1,3-butadiene monomer will be used alone or in combination with a styrene monomer. The modified diene elastomer is thus selected from the group consisting of polybutadienes and copolymers of butadiene and styrene. More preferentially still, the modified diene elastomer is a copolymer of styrene and butadiene.

The diene elastomers can have any microstructure, which depends on the polymerization conditions used. The diene elastomers can be block, random, sequential, or microsequential elastomers. Preferentially, the diene elastomer is a random diene elastomer.

It is possible to add, to the polymerization medium, a polar compound, preferably a compound belonging to the group consisting of diethers, diamines, tetrahydrofurans (such as THF), and tetrahydrofurfuryl ethers. Tetramethylethylenediamine is preferentially suitable as diamine. Particularly suitable as diethers are 1,2-diethoxyethane, 1,2-dimethoxyethane, and tetrahydrofurfuryl ethers such as tetrahydrofurfuryl ethyl ether and tetrahydrofurfuryl propyl ether.

The first step of the process generates living diene elastomer chains having a reactive site at the chain end. These living chains, or living diene elastomers, subsequently react with the modifying agent during the modification step.

Preferentially, the modifying agent comprises at least one atom bearing at least two functions reactive with respect to the living diene elastomer, this atom being selected from the group consisting of phosphorus, tin and silicon atoms. Those skilled in the art will readily understand that the number of elastomer branches cannot be less than two and cannot be greater than the valence of the atom bearing said at least two reactive functions.

More preferentially still, the at least two reactive functions of the modifying agent, which may be identical or different, are selected from the group consisting of halogen atoms, C1-C10 alkoxy groups and C6-C12 aryloxy groups; preferably they are selected from the group consisting of halogen atoms, C1-C4 alkoxy groups and C6-C12 aryloxy groups.

The expression “Cᵢ-Cⱼ alkyl” is understood to mean a linear, branched or cyclic hydrocarbon group comprising from i to j carbon atoms; i and j being integers.

The expression “Cᵢ-Cⱼ alkyloxy” is understood to mean an —O-alkyl group comprising from i to j carbon atoms; i and j being integers; alkyl being as defined above.

The expression “Cᵢ-Cⱼ aryl” is understood for the purposes of the present invention to mean one or more aromatic rings having from I to j carbon atoms, these possibly being joined or fused.

In particular, the aryl groups can be monocyclic or bicyclic groups, preferably monocyclic groups. By way of example, an aryl can be phenyl. In the context of the present invention, the aryl groups can be substituted by one or more identical or different substituents. Among the substituents of the aryl groups, mention may be made, by way of example, of alkyl groups (as defined above).

The expression “Cᵢ-Cⱼ aryloxy” is understood to mean an —O-aryl group comprising from i to j carbon atoms; i and j being integers; aryl being as defined above.

In one embodiment, the atom bearing two reactive functions can also be substituted by a function capable of interacting with a reinforcing filler.

More preferentially still, the modifying agent corresponds to the following general formula (I):

Z(R₂)ₚ(T)ᵣ(R₃—Y)_{q} (I)

in which:
Z represents an atom selected from the group consisting of Si, Sn and P;
T represents a halogen atom or an OR₄ radical with R₄ a C1-C10 alkyl or a C6-C12 aryl;
R₂ represents, independently at each occurrence, a C1-C10 alkyl, preferably a C1-C4 alkyl;
R₃ represents a saturated or unsaturated, cyclic or non-cyclic, divalent C1-C18 aliphatic hydrocarbon radical, or a divalent C6-C18 aromatic hydrocarbon radical; preferably a C1-C10 alkanediyl;
Y is a hydrogen atom or a function capable of interacting with a reinforcing filler;
p represents an integer equal to 0, 1 or 2;
q represents an integer equal to 0 or 1;
r represents an integer equal to 2, 3 or 4;
   with the proviso that:
when Z is P then q is equal to 0, p is equal to 0 or 1 and r+p=3;
when Z is Sn then q is equal to 0 and r+p=4;
when Z is Si then r+p+q=4.

The expression “Ci-Cj alkanediyl” is understood to mean, for the purposes of the present invention, a divalent group of general formula CₙH₂ₙ, derived from an alkane having between i and j carbon atoms. The divalent group may be linear or branched and optionally be substituted.

The term “halogen” denotes an atom selected from the group formed of fluorine (F), chlorine (Cl), bromine (Br) and iodine (I). Preferably, in formula (I), the halogen is chlorine.

Preferably, in formula (I), R₄, independently at each occurrence, represents a C1-C8 alkyl or a C6-C12 aryl, more preferentially a C1-C4 alkyl or a C6 aryl. More preferentially still, R₄, independently at each occurrence, represents a methyl, an ethyl or a phenyl that is unsubstituted or substituted by one or more C1-C6 alkyls. More preferentially still, R₄, independently at each occurrence, represents a methyl, an ethyl or a phenyl that is unsubstituted or substituted by one or more t-butyl groups.

Preferably, in formula (I), R₂, independently at each occurrence, represents a methyl, an ethyl or a propyl.

Preferably, in formula (I), R₃ is a C1-C10 alkanediyl, more preferentially a C1-C6 alkanediyl, and more preferentially still propanediyl.

Preferably, in formula (I), the function capable of interacting with the reinforcing filler comprises at least one heteroatom selected from nitrogen, sulfur, oxygen and phosphorus.

Preferably, in formula (I), the function capable of interacting with the reinforcing filler is a function selected from the group consisting of primary, secondary or tertiary amines, isocyanates, imines, cyanos, thiols, carboxylates, epoxides and primary, secondary or tertiary phosphines.

Preferably, in formula (I), the function capable of interacting with a reinforcing filler is preferentially a protected or unprotected primary amine, a protected or unprotected secondary amine or a tertiary amine. The nitrogen atom can then be substituted by two identical or different groups which can be a trialkylsilyl radical, the alkyl group having 1 to 4 carbon atoms, or a C₁-C₁₀ alkyl, preferably C₁-C₄ alkyl, radical, more preferentially a methyl or ethyl radical, or else the two substituents of the nitrogen form, with the latter, a heterocycle containing a nitrogen atom and at least one carbon atom, preferably from 2 to 6 carbon atoms.

Mention may be made, as modifying agent of formula (I) of which the function capable of interacting with a reinforcing filler is an amine, of (N,N-dialkylaminopropyl)trialkoxysilanes, (N,N-dialkylaminopropyl)alkyldialkoxysilanes, (N-alkylaminopropyl)trialkoxysilanes and (N-alkylaminopropyl)alkyldialkoxysilanes, the secondary amine function of which is protected by a trialkylsilyl group, and aminopropyltrialkoxysilanes and aminopropylalkyldialkoxysilanes, the primary amine function of which is protected by two trialkylsilyl groups. The alkyl substituents present on the nitrogen atom are linear or branched and advantageously have from 1 to 10 carbon atoms, preferably 1 to 4, more preferentially 1 or 2. Suitable, for example, as alkyl substituents are the methylamino-, dimethylamino-, ethylamino-, diethylamino-, propylamino-, dipropylamino-, butylamino-, dibutylamino-, pentylamino-, dipentylamino, hexylamino, dihexylamino or hexamethyleneimino groups, preferably the diethylamino and dimethylamino groups. The alkoxy substituents are linear or branched and generally have from 1 to 10 carbon atoms, indeed even 1 to 8, preferably from 1 to 4 and more preferentially 1 or 2.

Preferentially, the modifying agent of formula (I) can be selected from (3-N,N-dialkylaminopropyl)trialkoxysilanes and (3-N,N-dialkylaminopropyl)alkyldialkoxysilanes, the alkyl group being the methyl or ethyl group and the alkoxy group being the methoxy or ethoxy group.

Preferentially, the modifying agent of formula (I) can be selected from (3-N,N-alkyltrimethylsilylaminopropyl)trialkoxysilanes and (3-N,N-alkyltrimethylsilylaminopropyl)alkyldialkoxysilanes, the alkyl group being the methyl or ethyl group and the alkoxy group being the methoxy or ethoxy group.

Preferentially, the modifying agent of formula (I) can be selected from (3-N,N-bistrimethylsilylaminopropyl)trialkoxysilanes and (3-N,N-bistrimethylsilylaminopropyl)alkyldialkoxysilanes, the alkyl group being the methyl or ethyl group and the alkoxy group being the methoxy or ethoxy group.

Preferentially, the modifying agent of formula (I) can be selected from (3-N,N-dimethylaminopropyl)trimethoxysilane, (3-N,N-dimethylaminopropyl)triethoxysilane, (3-N,N-diethylaminopropyl)trimethoxysilane, (3-N,N-diethylaminopropyl)triethoxysilane, (3-N,N-dipropylaminopropyl)trimethoxysilane, (3-N,N-dipropylaminopropyl)triethoxysilane, (3-N,N-dibutylaminopropyl)trimethoxysilane, (3-N,N-dibutylaminopropyl)triethoxysilane, (3-N,N-dipentylaminopropyl)trimethoxysilane, (3-N,N-dipentylaminopropyl)triethoxysilane, (3-N,N-dihexylaminopropyl)trimethoxysilane, (3-N,N-dihexylaminopropyl)triethoxysilane, (3-hexamethyleneaminopropyl)trimethoxysilane, (3-hexamethyleneaminopropyl)triethoxysilane, (3-morpholinopropyl)trimethoxysilane, (3-morpholinopropyl)triethoxysilane, (3-piperidinopropyl)trimethoxysilane or (3-piperidinopropyl)triethoxysilane. More preferentially, the modifying agent of formula (I) is (3-N,N-dimethylaminopropyl)trimethoxysilane.

Preferentially, the modifying agent of formula (I) can be selected from (3-N,N-methyltrimethylsilylaminopropyl)trimethoxysilane, (3-N,N-methyltrimethylsilylaminopropyl)triethoxysilane, (3-N,N-ethyltrimethylsilylaminopropyl)trimethoxysilane, (3-N,N-ethyltrimethylsilylaminopropyl)triethoxysilane, (3-N,N-propyltrimethylsilylaminopropyl)trimethoxysilane or (3-N,N-propyltrimethylsilylaminopropyl)triethoxysilane. More preferentially, the modifying agent of formula (I) is (3-N,N-methyltrimethylsilylaminopropyl)trimethoxysilane.

According to another embodiment, the function capable of interacting with a reinforcing filler is an isocyanate function. Preferentially, the modifying agent of formula (I) can be selected from (3-isocyanatopropyl)trialkoxysilanes and (3-isocyanatopropyl)alkyldialkoxysilanes, the alkyl group being the methyl or ethyl group and the alkoxy group being the methoxy or ethoxy group. More preferentially still, the modifying agent of formula (I) is (3-isocyanatopropyl)dimethylaminopropyl)trimethoxysilane and (3-isocyanatopropyl)triethoxysilane.

According to another embodiment, the function capable of interacting with a reinforcing filler is an imine function. Preferentially, the modifying agent of formula (I) can be selected from N-(1,3-dimethylbutylidene)-3-(trimethoxysilyl)-1-propanamine, N-(1,3-dimethylbutylidene)-3-(triethoxysilyl)-1-propanamine, N-(1,3-methylethylidene)-3-(trimethoxysilyl)-1-propanamine, N-(1,3-methylethylidene)-3-(triethoxysilyl)-1-propanamine, N-ethylidene-3-(trimethoxysilyl)-1-propanamine, N-ethylidene-3-(triethoxysilyl)-1-propanamine, N-(1-methylpropylidene)-3-(trimethoxysilyl)-1-propanamine, N-(1-methylpropylidene)-3-(triethoxysilyl)-1-propanamine, N-(4-N,N-dimethylaminobenzylidene)-3-(trimethoxysilyl)-1-propanamine, N-(4-N,N-dimethylaminobenzylidene)-3-(triethoxysilyl)-1-propanamine, N-(cyclohexylidene)-3-(trimethoxysilyl)-1-propanamine, N-(cyclohexylidene)-3-(triethoxysilyl)-1-propanamine, N-(3-trimethoxysilylpropyl)-4,5-dihydroimidazole, N-(3-triethoxysilylpropyl)-4,5-dihydroimidazole, N-(3-trimethoxysilylpropyl)-4,5-imidazole and N-(3-triethoxysilylpropyl)-4,5-imidazole.

According to another embodiment, the function capable of interacting with a reinforcing filler is a cyano function. Preferentially, the modifying agent of formula (I) can be selected from (3-cyanopropyl)trialkoxysilanes and (3-cyanopropyl)alkyldialkoxysilanes, the alkyl group being the methyl or ethyl group and the alkoxy group being the methoxy or ethoxy group. More preferentially, the modifying agent of formula (I) can be selected from (3-cyanopropyl)trimethoxysilane and (3-cyanopropyl)triethoxysilane.

According to another embodiment, the function capable of interacting with a reinforcing filler is a protected or unprotected function derived from thiol —SR, R being a protecting group or H. As examples, mention may be made of (S-trialkylsilylmercaptopropyl)trialkoxysilanes and (S-trialkylsilylmercaptopropyl)alkyldialkoxysilanes, the alkyl group on the silicon atom bearing alkoxysilane groups being the methyl or ethyl group and the alkoxy group being the methoxy or ethoxy group. The alkyl group on the silicon bonded to the sulfur atom is the methyl or tert-butyl group. Preferentially, the modifying agent of formula (I) can be selected from (S-trimethylsilylmercaptopropyl)trimethoxysilane, (S-trimethylsilylmercaptopropyl)triethoxysilane, (S-tert-butyldimethylsilylmercaptopropyl)trimethoxysilane and (S-tert-butyldimethylsilylmercaptopropyl)triethoxysilane.

According to another embodiment, the function capable of interacting with a reinforcing filler is a carboxylate function. Mention may be made, as carboxylate function, of acrylates or methacrylates. Such a function is preferably a methacrylate. Preferentially, the modifying agent of formula (I) can be selected from (3-methacryloyloxypropyl)trialkoxysilanes and (3-methacryloyloxypropyl)alkyldialkoxysilanes, the alkyl group being the methyl or ethyl group and the alkoxy group being the methoxy or ethoxy group. Preferentially, the modifying agent of formula (I) can be selected from (3-methacryloyloxypropyl)trimethoxysilane and (3-methacryloyloxypropyl)triethoxysilane.

According to another embodiment, the function capable of interacting with a reinforcing filler is an epoxide function. Preferentially, the modifying agent of formula (I) can be selected from (3-glycidyloxypropyl)trialkoxysilanes and (3-glycidyloxypropyl)alkyldialkoxysilanes, the alkyl group being the methyl or ethyl group and the alkoxy group being the methoxy or ethoxy group. Preferentially, the modifying agent of formula (I) can be selected from (2-glycidyloxyethyl)trimethoxysilane, (2-glycidyloxyethyl)triethoxysilane, (3-glycidyloxypropyl)trimethoxysilane, (3-glycidyloxypropyl)triethoxysilane, 2-(3,4-epoxycyclohexyl)ethyltrimethoxysilane or 2-(3,4-epoxycyclohexyl)ethyltriethoxysilane.

According to another embodiment, the function capable of interacting with a reinforcing filler is a protected or unprotected primary phosphine function, a protected or unprotected secondary phosphine function or a tertiary phosphine function. Preferentially, the modifying agent of formula (I) can be selected from (3-P,P-bistrimethylsilylphosphinopropyl)trialkoxysilanes, (3-P,P-bistrimethylsilylphosphinopropyl)alkyldialkoxysilanes, (3-P,P-alkyltrimethylsilylphosphinopropyl)trialkoxysilanes, (3-P,P-alkyltrimethylsilylphosphinopropyl)alkyldialkoxysilanes, (3-P,P-dialkylphosphinopropyl)trialkoxysilanes and (3-P,P-dialkylphosphinopropyl)alkyldialkoxysilanes, the alkyl group being the methyl, ethyl or phenyl group and the alkoxy group being the methoxy or ethoxy group. Preferentially, the modifying agent of formula (I) can be selected from (3-P,P-bistrimethylsilylphosphinopropyl)trimethoxysilane, (3-P,P-bistrimethylsilylphosphinopropyl)triethoxysilane, (3-methyltrimethylsilylphosphinopropyl)trimethoxysilane, (3-methyltrimethylsilylphosphinopropyl)triethoxysilane, (3-ethyltrimethylsilylphosphinopropyl)trimethoxysilane, (3-ethyltrimethylsilylphosphinopropyl)triethoxysilane, (3-dimethylphosphinopropyl)trimethoxysilane, (3-dimethylphosphinopropyl)triethoxysilane, (3-diethylphosphinopropyl)trimethoxysilane, (3-diethylphosphinopropyl)triethoxysilane, (3-ethylmethylphosphinopropyl)trimethoxysilane, (3-ethylmethylphosphinopropyl)triethoxysilane, (3-diphenylphosphinopropyl)trimethoxysilane and (3-diphenylphosphinopropyl)triethoxysilane.

More preferentially still, the preferred agent of formula (I) can have the following characteristics:
Z represents an atom selected from the group consisting of P, Sn and Si; preferably P or Si;
T represents a halogen atom, preferably chlorine, or an OR₄ radical with R₄ a C1-C4 alkyl or a C6 aryl;
R₂ represents, independently at each occurrence, a C1-C4 alkyl; more preferentially methyl or ethyl;
R₃ represents a C1-C6 alkanediyl, more preferentially propanediyl;
Y is an amine function capable of interacting with a reinforcing filler;
p represents an integer equal to 0, 1 or 2;
q represents an integer equal to 0 or 1;
r represents an integer equal to 2, 3 or 4;
   with the proviso that:
when Z is P then q is equal to 0, p is equal to 0 or 1 and r+p=3;
when Z is Sn then q is equal to 0 and r+p=4;
when Z is Si then r+p+q=4.

According to a variant, those agents which are preferred among the modifying agents of formula (I) are those of formula (I) where q is equal to 1.

Preferentially, in the variant where q=1, the modifying agents of formula (I) which are even more preferred can be those for which: Z represents a silicon atom; T represents a halogen atom or an OR₄ radical with R₄ a C1-C10 alkyl; R₂ represents, independently at each occurrence, a C1-C10 alkyl, preferably a C1-C4 alkyl; R₃ represents a C1-C10 alkanediyl; Y is a hydrogen atom or a function capable of interacting with a reinforcing filler; p represents an integer equal to 0, 1 or 2; r represents an integer equal to 2, 3 or 4; and r+p+q=4.

According to another variant, those agents which are preferred among the modifying agents of formula (I) are those of formula (I) where q is equal to 0.

Preferentially, in the variant where q=0, the modifying agents of formula (I) which are even more preferred can be those for which: Z represents a phosphorus atom; T represents a halogen atom or an OR₄ radical with R₄ a C1-C10 alkyl or a C6 aryl; R₂ represents, independently at each occurrence, a C1-C10 alkyl, preferably a C1-C4 alkyl; p represents an integer equal to 0 or 1; r represents an integer equal to 2 or 3 and r+p=3.

When in formula (I) q is equal to 0, mention may then be made, as examples of modifying agent, of compounds such as tin tetrachloride, methyltin trichloride, dimethyltin dichloride, dibutyltin dichloride, tetrachlorosilane, methyltrichlorosilane and dimethyldichlorosilane, tetraalkoxysilanes which are such that each alkyl group comprises from 1 to 10 carbon atoms, preferably from 1 to 4 carbon atoms, trialkyl phosphites which are such that each alkyl group comprises from 1 to 10 carbon atoms or triaryl phosphites which are such that each aryl group comprises from 6 to 12 carbon atoms, the aryl groups possibly being substituted by one or more C1-C6 alkyls; preferably substituted by one or more t-butyl groups. As particularly preferred modifying agent of formula (I), mention may be made of dimethyltin, dibutyltin dichloride, tetrachlorosilane, methyltrichlorosilane, dimethyldichlorosilane, tris(nonylphenyl) phosphite and tris(2,4-di(tert-butyl)phenyl) phosphite.

The amount of modifying agent intended to react with the living diene elastomer depends essentially on the type of modified diene elastomer desired. In general, the molar ratio of groups of the agent that are reactive with respect to the living elastomer, to the metal of the polymerization initiator, is at least 0.05, preferably at least 0.10, more preferentially at least 0.15, and at most 0.70, preferentially at most 0.60.

Thus, according to a particularly advantageous variant of the invention, the molar ratio of the modifying agent to the metal of the polymerization initiator has a value within a range extending from 0.20 to 0.55.

The conditions for addition of the modifying agent to the living diene elastomer and for reaction thereof with said living diene elastomer are conventional as regards modification in anionic polymerization and are known to a person skilled in the art. These conditions do not comprise specific limitations. Preferably, the organic solvent used during the step of modifying the diene elastomer with the modifying agent is the same as that used during the anionic polymerization step.

For example, this modification reaction with the living diene elastomer can take place at a temperature of between −20° C. and 100° C., by addition of the modifying agent to the living elastomer chains, or vice versa. This reaction can, of course, be carried out with one or more different modifying agents.

The mixing of the living elastomer with the modifying agent can be carried out by any suitable means, in particular using any mixer having available stirring of static type and/or any dynamic mixer of perfectly stirred type known to those skilled in the art. The latter determines the reaction time between the living diene polymer and the modifying agent, which can vary from a few minutes, for example two minutes, to several hours, for example two hours.

A person skilled in the art will know how to adapt the anionic polymerization and modification conditions to obtain a modified diene elastomer having a Tg measured according to the standard ASTM D3418-08 measured before its extension with the resin of within a range extending from −95° C. to −70° C., preferably within a range extending from −90° C. to −80° C.

On conclusion of the step of modifying the living diene elastomer, at least one plasticizing resin as defined below is added to the solution comprising the modified diene elastomer having a number-average molar mass Mn2 measured by triple detection size exclusion chromatography.

The plasticizing resin may be added directly to said modified diene elastomer solution, that is to say by adding the resin in solid form, or else the resin in solid form may be dissolved beforehand in an organic solvent, preferably in the same organic solvent as that used in the preceding step, that is to say in the modification step and/or in the polymerization step. In another variant of the process, the resin may be heated to a temperature greater than its softening point and be incorporated into the solution containing the modified diene elastomer in molten form.

After homogenization of the organic solvent solution comprising said modified diene elastomer and said plasticizing resin, the solvent is removed by any means known to those skilled in the art, such as, for example, steam stripping. The resin-extended modified diene elastomer is recovered in the form of “crumb” which can be washed and dried, and possibly shaped in the form of rubber balls for their storage.

Preferentially, in a variant of the process for manufacturing the resin-extended modified diene elastomer according to the invention, it is possible, before the step of removing the organic solvent, to add an extender oil. Suitable in particular as extender oil are the plasticizing oils selected from the group consisting of naphthenic oils (low- or high-viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, plant oils, ether plasticizers, ester plasticizers, phosphate plasticizers, sulfonate plasticizers and the mixtures of these compounds. The extender oil content added will always be lower than the resin content added to the modified diene elastomer in solution.

More preferentially, the process for manufacturing the resin-extended modified diene elastomer, irrespective of the variant used, does not comprise adding a plasticizing oil before removing the organic solvent.

Thus, as indicated above, the resin-extended modified diene elastomer according to the invention has the following characteristics: it comprises within its structure a branching unit and at least two diene elastomer branches obtained by anionic polymerization of at least one conjugated diene monomer having from 4 to 12 carbon atoms, the resin and the elastomer being intimately mixed, it has a number-average molar mass Mn1 measured before the modification step by triple detection size exclusion chromatography, it has a number-average molar mass Mn2 measured after the modification step by triple detection size exclusion chromatography of greater than or equal to 200 000 g/mol and an Mn2/Mn1 ratio of strictly greater than 1.00, it has a glass transition temperature measured according to the standard ASTM D3418-08 and before its extension with the resin of within a range extending from −95° C. to −70° C.

More preferentially, the branching unit of the resin-extended diene elastomer comprises at least one atom selected from the group consisting of a phosphorus atom, a silicon atom and a tin atom.

Preferentially and in addition to the abovementioned characteristics, the resin-extended modified diene elastomer according to the invention comprises branched chains and may correspond to the following general formula (II):

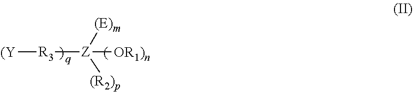

in which:
E represents a branch of the diene elastomer;
Z represents an atom selected from the group consisting of P, Si and Sn;
R₁ represents, independently at each occurrence, a hydrogen atom, a C1-C10 alkyl or a C6-C12 aryl;
R₂ represents, independently at each occurrence, a C1-C10 alkyl, preferably C1-C4 alkyl;
R₃ represents a saturated or unsaturated, cyclic or non-cyclic, divalent C1-C18 aliphatic hydrocarbon radical, or a divalent C6-C18 aromatic hydrocarbon radical; preferably R₃ is a C1-C10 alkanediyl;
Y represents a hydrogen atom or a function capable of interacting with a reinforcing filler;
m is an integer being equal to 2, 3 or 4;
n is an integer being equal to 0, 1 or 2;
p is an integer being equal to 0, 1 or 2;
q is an integer being equal to 0 or 1; and
with the proviso that when
   Z=P then q=0, m=2 or 3 and m+n+p=3;
   Z=Sn then q=0 and m+n+p=4;
   Z=Si then m+n+p+q=4.

According to a variant of the invention, in formula (II), R₁, independently at each occurrence, can represent a C1-C8 alkyl or a C6-C12 aryl, more preferentially a C1-C4 alkyl or a C6 aryl. More preferentially still, R₄, independently at each occurrence, can represent a methyl, an ethyl or a phenyl that is unsubstituted or substituted by one or more C1-C6 alkyls. More preferentially still, R₁, independently at each occurrence, can represent a methyl, an ethyl or a phenyl that is unsubstituted or substituted by one or more t-butyl groups.

According to a variant of the invention, in formula (II), R₂, independently at each occurrence, can represent a methyl, an ethyl or a propyl.

According to a variant of the invention, in formula (II), R₃ can be a C1-C10 alkanediyl, preferably a C1-C6 alkanediyl, more preferentially still propanediyl.

According to a variant of the invention, in formula (II), the function capable of interacting with a reinforcing filler can comprise at least one heteroatom selected from nitrogen, sulfur, oxygen and phosphorus.

Preferentially in a variant of the invention, in formula (II), the function capable of interacting with the reinforcing filler is a primary, secondary or tertiary amine function, isocyanates, imines, cyanos, thiols, carboxylates, epoxides or primary, secondary or tertiary phosphines.

Mention may thus be made, as secondary or tertiary amine function, of amines substituted by C1-C10 alkyl, preferably C1-C4 alkyl, radicals, more preferentially a methyl or ethyl radical, or else of cyclic amines forming a heterocycle containing a nitrogen atom and at least one carbon atom, preferably from 2 to 6 carbon atoms. Suitable, for example, are the methylamino-, dimethylamino-, ethylamino-, diethylamino-, propylamino-, dipropylamino-, butylamino-, dibutylamino-, pentylamino-, dipentylamino-, hexylamino-, dihexylamino- or hexamethyleneamino-groups, preferably the diethylamino- and dimethylamino-groups.

Mention may be made, as imine function, of ketimines. Suitable, for example, are the (1,3-dimethylbutylidene)amino-, (ethylidene)amino-, (1-methylpropylidene)amino-, (4-N,N-dimethylaminobenzylidene)amino-, (cyclohexylidene)amino-, dihydroimidazole and imidazole groups.

Mention may thus be made, as carboxylate function, of acrylates or methacrylates. Such a function is preferably a methacrylate.

Mention may be made, as epoxide function, of the epoxy or glycidyloxy groups.

Mention may be made, as secondary or tertiary phosphine function, of phosphines substituted by C1-C10 alkyl, preferably C1-C4 alkyl, radicals, more preferentially a methyl or ethyl radical, or else diphenylphosphine. Suitable, for example, are the methylphosphino-, dimethylphosphino-, ethylphosphino-, diethylphosphino, ethylmethylphosphino- and diphenylphosphino-groups.

More preferentially still, the preferred resin-extended modified diene elastomer of formula (II) can be the one in which:
E represents a branch of a butadiene homopolymer or a butadiene copolymer; preferably a branch of a polybutadiene or of a copolymer of styrene and butadiene.
Z represents an atom selected from the group consisting of P, Sn and Si; preferably P or Si;
R₁ represents, independently at each occurrence, a hydrogen atom or a C1-C4 alkyl or a C6 aryl;
R₂ represents, independently at each occurrence, a C1-C4 alkyl; more preferentially methyl or ethyl;
R₃ represents a C1-C6 alkanediyl, more preferentially propanediyl;
Y is an amine function capable of interacting with a reinforcing filler;
m represents an integer equal to 2, 3 or 4;
n represents an integer equal to 0, 1 or 2;
p represents an integer equal to 0, 1 or 2;
q represents an integer equal to 0 or 1;
with the proviso that when
   Z=P then q=0, m=2 or 3 and m+n+p=3;
   Z=Sn then q=0 and m+n+p=4;
   Z=Si then m+n+p+q=4.

According to a variant of the invention, among the elastomers of formula (II), preference is given to those where q is equal to 1.

More preferentially in the variant where q=1, the elastomers of formula (II) can be those for which: E represents a branch of a butadiene homopolymer or of a butadiene copolymer; preferably a branch of a polybutadiene or of a copolymer of styrene and butadiene; Z represents a silicon atom; R₁ represents, independently at each occurrence, a C1-C10 alkyl; R₂ represents, independently at each occurrence, a C1-C10 alkyl, preferably C1-C4 alkyl; R₃ represents a C1-C10 alkanediyl; Y is a hydrogen atom or a function capable of interacting with a reinforcing filler; n represents an integer equal to 0, 1 or 2; p represents an integer equal to 0, 1 or 2; m represents an integer equal to 2, 3 or 4; and m+n+p+q=4.

According to another variant of the invention, among the elastomers of formula (II), preference is given to those where q is equal to 0.

More preferentially in the variant where q=0, the elastomers of formula (II) can be those for which: E represents a branch of a butadiene homopolymer or of a butadiene copolymer; preferably a branch of a polybutadiene or of a copolymer of styrene and butadiene; Z represents a phosphorus atom; R₁, independently at each occurrence, represents a C1-C10 alkyl or a C6 aryl; R₂ represents, independently at each occurrence, a C1-C10 alkyl, preferably C1-C4 alkyl; n represents an integer equal to 0, 1 or 2; p represents an integer equal to 0 or 1; m represents an integer equal to 2 or 3 and m+n+p=3.

The second constituent of the resin-extended modified diene elastomer in accordance with the invention is a plasticizing resin.

As is known to those skilled in the art, the term “resin” is reserved in the present patent application, by definition, for a compound which is solid at ambient temperature (23° C., 1 atm), as opposed to a plasticizer that is liquid at ambient temperature such as an oil.

Plasticizing resins are polymers that are well known to those skilled in the art. These are hydrocarbon resins essentially based on carbon and hydrogen, but which may include other types of atoms, which can be used in particular as plasticizing agents or tackifying agents in polymer matrices. They are by nature miscible (i.e. compatible) at the contents used with the compositions of diene elastomer(s) for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, or of the aliphatic/aromatic type, that is to say based on aliphatic and/or aromatic monomers. They can be natural or synthetic and may or may not be petroleum-based (if such is the case, they are also known under the name of petroleum resins). They are preferentially exclusively hydrocarbon-based, i.e. they include only carbon and hydrogen atoms. Their Tg is preferably greater than or equal to 0° C., preferably greater than or equal to 20° C. (usually in a range extending from 30° C. to 95° C.). In the present patent application, the terms “plasticizing resins”, “hydrocarbon resins” and “plasticizing hydrocarbon resins” are interchangeable. The Tg of the resins that can be used within the context of the present invention is measured in accordance with the standard ASTM D3418-08 (2008).

As is known, these plasticizing resins can also be described as thermoplastic resins in the sense that they soften when heated and can thus be moulded. They can also be defined by a softening point or temperature. The softening point of a plasticizing resin is generally approximately 50° C. to 60° C. higher than its Tg value. The softening point is measured in accordance with the standard ISO 4625 of 2012 (ring and ball method).

Preferentially, the plasticizing resin that can be used within the context of the present invention has a Tg of greater than or equal to 0° C., preferably greater than or equal to 20° C., preferably greater than or equal to 30° C. (in particular between 30° C. and 95° C.). It is understood that the Tg of the plasticizing resin included in the formulation of the resin-extended modified diene elastomer in accordance with the invention is measured on the plasticizing resin prior to mixing it with the modified diene elastomer.

Preferentially, the plasticizing resin that can be used within the context of the present invention has a softening point of greater than or equal to 50° C. (in particular of between 50° C. and 150° C.) measured in accordance with the standard ISO 4625 of 2012 (ring and ball method).

Preferentially, the plasticizing resin that can be used in the context of the present invention has a number-average molar mass (Mn) of between 400 and 2000 g/mol, preferentially between 500 and 1500 g/mol.

Preferentially, the plasticizing resin that can be used within the context of the present invention has a polydispersity index (PDI) of less than 3 (reminder: PDI=Mw/Mn with Mw the weight-average molar mass). The Mn, the Mw and the PDI of the plasticizing resins are measured according to the refractive index size exclusion chromatography method as described above.

More preferentially, the plasticizing resin that can be used within the context of the present invention can have a Tg of greater than or equal to 20° C., preferably greater than or equal to 30° C., and an Mn of between 400 and 2000 g/mol, preferentially between 500 and 1500 g/mol.

More preferentially, the plasticizing resins that can be used within the context of the present invention can have all of the preferential characteristics above.

Preferentially, the plasticizing resin that can be used within the context of the present invention is selected from the group consisting of aliphatic resins, aromatic resins and mixtures of these resins.

As examples of such plasticizing resins that can be used within the context of the present invention, mention may be made of those selected from the group consisting of cyclopentadiene (abbreviated as CPD) homopolymer or copolymer resins, dicyclopentadiene (abbreviated as DCPD) homopolymer or copolymer resins, terpene homopolymer or copolymer resins, C5 cut homopolymer or copolymer resins, C9 cut homopolymer or copolymer resins, mixtures of C5 cut homopolymer or copolymer resins and of C9 cut homopolymer or copolymer resins, α-methylstyrene homopolymer or copolymer resins, and mixtures of these resins.

All of the above plasticizing resins are well known to those skilled in the art and are commercially available, for example sold by Exxon Mobil under the name Escorez as regards C5 cut/styrene resins or C5 cut resins or C9 cut resins and CPD or DCPD resins.

Preferentially, the content of plasticizing resin in the resin-extended elastomer is in a range extending from 5 to 100 phr, preferably from 30 to 80 phr. The content of plasticizing resin in the resin-extended modified diene elastomers was measured according to the method described above.

Rubber Composition Comprising the Resin-Extended Modified Diene Elastomer The modified diene elastomer of the invention as defined above can be used in any rubber compositions, in particular those intended for the manufacture of semi-finished articles for tyres and for the manufacture of tyres.

Thus, another subject of the present invention relates to a rubber composition based on at least one resin-extended modified diene elastomer as defined above, a reinforcing filler and a crosslinking system.

Use may be made of any type of “reinforcing” filler known for its abilities to reinforce a rubber composition which can be used in particular for the manufacture of tyres, for example an organic filler, such as carbon black, an inorganic filler, such as silica, or else a mixture of these two types of fillers.

Suitable as carbon blacks are all carbon blacks, in particular the blacks conventionally used in tyres or their treads. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks may be used in isolated form, as commercially available, or in any other form, for example as support for some of the rubber additives used. The carbon blacks might, for example, be already incorporated in the diene elastomer, in particular isoprene elastomer, in the form of a masterbatch (see, for example, application WO97/36724-A2 or WO99/16600-A1).

“Reinforcing inorganic filler” should be understood here as meaning any inorganic or mineral filler, whatever its colour and its origin (natural or synthetic), also referred to as “white” filler, “clear” filler or even “non-black” filler, in contrast to carbon black, capable of reinforcing, by itself alone, without means other than an intermediate coupling agent, a rubber composition intended for the manufacture of tyres. In a known way, some reinforcing inorganic fillers can be characterized in particular by the presence of hydroxyl (—OH) groups at their surface.

Suitable in particular as reinforcing inorganic fillers are mineral fillers of the siliceous type, preferentially silica (SiO₂), or of the aluminous type, in particular alumina (Al₂O₃). The silica used can be any reinforcing silica known to those skilled in the art, in particular any precipitated or fumed silica having a BET specific surface area and also a CTAB specific surface area both of less than 450 m²/g, preferably within a range extending from 30 to 400 m²/g, in particular from 60 to 300 m²/g. Any type of precipitated silica, in particular highly dispersible precipitated silicas (referred to as “HDS” for “highly dispersible” or “highly dispersible silica”), can be used.

These precipitated silicas, which are or are not highly dispersible, are well known to those skilled in the art. Mention may be made, for example, of the silicas described in patent applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

According to an advantageous variant of the invention, the reinforcing filler is predominantly silica, that is to say that it comprises more than 50% by weight, of the total weight of the reinforcing filler, of silica.

The use of silica as reinforcing filler may require the use of a coupling agent in order to establish the connection between the filler and the elastomer. It is then possible to use, as coupling agents, organosilanes, in particular alkoxysilane polysulfides or mercaptosilanes, or also at least bifunctional polyorganosiloxanes.

Such a coupling agent should not be confused with the modifying agent used for the synthesis of the modified diene elastomer described above.

The rubber composition according to the invention can also in addition contain coupling activators, agents for covering the fillers or more generally processing aids capable, in a known way, by virtue of an improvement in the dispersion of the reinforcing filler within the resin-extended modified diene elastomer and of a lowering of the viscosity of the composition, of improving its ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

The rubber composition according to the invention can also additionally contain at least one plasticizer. In a way known to those skilled in the art of tyre rubber compositions, this plasticizer is preferably selected from resins with a high glass transition temperature (Tg), low-Tg resins, plasticizing oils and mixtures thereof. Preferably, the plasticizer is chosen from high-Tg resins, plasticizing oils and mixtures thereof. When the rubber composition also comprises a high-Tg resin, this resin can be identical to that used for the extension of the modified elastomer or can be of a different chemical nature.

By definition, a high-Tg resin is solid at ambient temperature (23° C. and 1 atm), a plasticizing oil is liquid at ambient temperature and a low-Tg hydrocarbon resin is viscous at ambient temperature. The Tg is measured according to standard ASTM D3418-08 (2008).

In a known way, the high-Tg hydrocarbon resins are thermoplastic resins, the Tg of which is greater than 20° C. The preferential high-Tg resins which can be used in the context of the invention are well known to those skilled in the art and are commercially available.

The plasticizer can optionally comprise a resin which is viscous at 20° C., referred to as “low-Tg” resin, that is to say which, by definition, has a Tg within a range between −40° C. and 20° C.

The plasticizer can also contain a plasticizing oil (or extender oil) which is liquid at 20° C., referred to as “low Tg”, that is to say which, by definition, has a Tg of less than 20° C., preferably of less than 40° C.

Any extender oil, whether it is of aromatic or non-aromatic nature, known for its plasticizing properties with regard to elastomers can be used. Suitable in particular are the plasticizing oils selected from the group consisting of naphthenic oils (low- or high-viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, plant oils, ether plasticizers, ester plasticizers, phosphate plasticizers, sulfonate plasticizers and the mixtures of these compounds.

The rubber composition in accordance with the invention can additionally also comprise all or some of the usual additives and processing aids known to those skilled in the art and generally used in rubber compositions for tyres, in particular rubber compositions of treads, such as, for example, non-reinforcing fillers, pigments, protective agents, such as antiozone waxes, chemical antiozonants or antioxidants, anti-fatigue agents or reinforcing resins (such as described, for example, in application WO 02/10269).

The rubber composition according to the invention comprises at least one crosslinking system, for example based on sulfur and other vulcanizing agents, and/or peroxide and/or bismaleimide.

The rubber composition in accordance with the invention is manufactured in appropriate mixers using two successive preparation phases well known to those skilled in the art:
a first phase of thermomechanical working or kneading (“non-productive” phase), which can be carried out in a single thermomechanical stage during which all the necessary constituents, in particular the resin-extended modified diene elastomer as defined above, the reinforcing filler(s) and the optional other various additives, with the exception of the crosslinking system, are introduced into an appropriate mixer, such as a standard internal mixer (for example of “Banbury” type). The incorporation of the reinforcing filler into the resin-extended modified diene elastomer can be performed in one or more portions while thermomechanically kneading. The non-productive phase is carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first non-productive phase down to a lower temperature, typically of less than 120° C., for example from 30° C. to 100° C. The crosslinking system is then incorporated and all of the ingredients are then mixed for a few minutes, for example between 5 and 15 min.

The final composition thus obtained is subsequently calendered, for example in the form of a sheet or of a slab, in particular for a laboratory characterization, or else extruded in the form of a rubber semi-finished product (or profiled element) which can be used, for example, as a vehicle tyre tread.

The composition may be either in the raw state (before crosslinking or vulcanization) or in the cured state (after crosslinking or vulcanization), and may be a semi-finished product which can be used in a tyre.

The crosslinking of the composition can be carried out in a manner known to those skilled in the art, for example at a temperature of between 130° C. and 200° C., under pressure.

Due to the maintenance of the compromise of hysteresis properties/raw processability/quality of its extrudate, it will be noted that such a composition according to the invention can constitute any semi-finished product of the tyre and particularly a tread.

Thus, another subject of the present invention relates to a semi-finished rubber article for a tyre comprising at least one crosslinkable or crosslinked composition as defined previously. Preferably, this semi-finished article is a tread.

Lastly, another subject of the present invention relates to the tyre comprising at least one rubber composition defined previously or a semi-finished article defined above.

A final subject of the invention is thus a tyre comprising a semi-finished article constituted, in all or in part, by a composition according to the invention, in particular a tread.

The invention, described in more detail above, relates to at least one of the embodiments listed in the following points:
1. Resin-extended modified diene elastomer capable of being obtained by a process comprising at least:
   a step of anionically polymerizing, in an organic solvent, at least one conjugated diene monomer having from 4 to 12 carbon atoms in the presence of a polymerization initiator to form a living diene elastomer having a number-average molar mass Mn1 measured by triple detection size exclusion chromatography;
   a step of modifying the living diene elastomer of number-average molar mass Mn1, in the organic solvent, by reaction with a modifying agent to form a modified diene elastomer having a number-average molar mass Mn2 measured by triple detection size exclusion chromatography and a glass transition temperature, measured according to the standard ASTM D3418-08, within a range extending from −95° C. to −70° C.;
   a step of adding at least one plasticizing resin to the organic solvent comprising the modified diene elastomer;
   a step of removing the organic solvent to obtain the resin-extended modified diene elastomer; and
      the resin-extended modified diene elastomer having an Mn2/Mn1 ratio of strictly greater than 1.00 and an Mn2 of greater than or equal to 200 000 g/mol.
2. Resin-extended modified diene elastomer according to Embodiment 1, wherein the number-average molar mass Mn2 is greater than or equal to 220 000 g/mol, more preferentially greater than or equal to 230 000 g/mol, more preferentially still greater than or equal to 250 000 g/mol.
3. Resin-extended modified diene elastomer according to either one of the preceding embodiments, wherein the number-average molar mass Mn1 is greater than or equal to 140 000 g/mol, preferably within a range extending from 150 000 g/mol to 200 000 g/mol.
4. Resin-extended modified diene elastomer according to any one of the preceding embodiments, wherein the Mn2/Mn1 ratio is greater than or equal to 1.10; more preferentially is greater than or equal to 1.20; preferably is within a range extending from 1.30 to 4.00, more preferentially is within a range extending from 1.40 to 2.00.
5. Resin-extended modified diene elastomer according to any one of the preceding embodiments, wherein the step of anionic polymerization is carried out additionally in the presence of at least one vinylaromatic monomer having from 8 to 20 carbon atoms.
6. Resin-extended modified diene elastomer according to any one of the preceding embodiments, wherein the vinylaromatic monomer having from 8 to 20 carbon atoms is selected from the group consisting of styrene, ortho-methylstyrene, meta-methylstyrene, para-methylstyrene, the vinyl-toluene commercial mixture, para-tert-butylstyrene, methoxystyrenes, chlorostyrenes, vinylmesitylene, divinylbenzene, vinylnaphthalene, and mixtures of these monomers.
7. Resin-extended modified diene elastomer according to either one of the preceding Embodiments 5 and 6, wherein the vinylaromatic monomer having from 8 to 20 carbon atoms is styrene.
8. Resin-extended modified diene elastomer according to any one of the preceding embodiments, wherein the conjugated diene monomer having from 4 to 12 carbon atoms is selected from the group consisting of 1,3-butadiene, 2-methyl-1,3-butadiene, 2,3-di(C1-C5 alkyl)-1,3-butadienes, 1,3-pentadiene, 2,4-hexadiene and mixtures of these monomers.
9. Resin-extended modified diene elastomer according to any one of the preceding embodiments, wherein the conjugated diene monomer having from 4 to 12 carbon atoms is 1,3-butadiene or 2-methyl-1,3-butadiene; preferably 1,3-butadiene.
10. Resin-extended modified diene elastomer according to any one of the preceding embodiments, wherein the polymerization initiator comprises a carbon-lithium bond or a nitrogen-lithium bond.
11. Resin-extended modified diene elastomer according to any one of the preceding embodiments, wherein the polymerization initiator is selected from the group consisting of ethyllithium, n-butyllithium, isobutyllithium, and lithium amides obtained from a cyclic secondary amine; preferably is n-butyllithium.
12. Resin-extended modified diene elastomer according to any one of the preceding embodiments, wherein the solvent of the anionic polymerization step is selected from the group consisting of aliphatic hydrocarbons, alicyclic hydrocarbons and aromatic hydrocarbons.
13. Resin-extended modified diene elastomer according to any one of the preceding embodiments, wherein the solvent of the anionic polymerization step is selected from the group consisting of hexane, heptane, isooctane, cyclohexane, cyclopentane, methylcyclohexane, benzene, toluene, xylene, and a mixture thereof.
14. Resin-extended modified diene elastomer according to any one of the preceding embodiments, wherein the solvent of the modification step is identical to the solvent of the anionic polymerization step.
15. Resin-extended modified diene elastomer according to any one of the preceding embodiments, wherein the plasticizing resin has a number-average molar mass within a range extending from 400 to 2000 g/mol measured by refractive index size exclusion chromatography, preferentially within a range extending from 500 to 1500 g/mol.
16. Resin-extended modified diene elastomer according to any one of the preceding embodiments, wherein the plasticizing resin has a glass transition temperature of greater than or equal to 0° C., preferably greater than or equal to 20° C., preferably greater than or equal to 30° C., more preferentially still within a range between 30° C. and 95° C.
17. Resin-extended modified diene elastomer according to any one of the preceding embodiments, wherein the plasticizing resin has a polydispersity index of less than 3.
18. Resin-extended modified diene elastomer according to any one of the preceding embodiments, wherein the content of plasticizing resin is within a range extending from 5 to 100 phr and preferably from 30 to 80 phr.
19. Resin-extended modified diene elastomer according to any one of the preceding embodiments, wherein the plasticizing resin is selected from the group consisting of aliphatic resins, aromatic resins and mixtures of these resins.
20. Resin-extended modified diene elastomer according to any one of the preceding embodiments, wherein the plasticizing resin is selected from the group consisting of cyclopentadiene homopolymer or copolymer resins, dicyclopentadiene homopolymer or copolymer resins, terpene homopolymer or copolymer resins, C5 cut homopolymer or copolymer resins, C9 cut homopolymer or copolymer resins, mixtures of C5 cut homopolymer or copolymer resins and of C9 cut homopolymer or copolymer resins, α-methylstyrene homopolymer or copolymer resins, and mixtures of these resins.
21. Resin-extended modified diene elastomer according to any one of the preceding embodiments, wherein the modifying agent comprises at least one atom bearing at least two functions reactive with the living diene elastomer, this atom being selected from the group consisting of a silicon atom, a phosphorus atom and a tin atom.
22. Resin-extended modified diene elastomer according to Embodiment 21, wherein the at least two functions reactive with the living diene elastomer, which may be identical or different, are selected from the group consisting of halogen atoms, C1-C10 alkoxy groups and C6-C12 aryloxy groups; preferably they are selected from the group consisting of halogen atoms, C1-C4 alkoxy groups and C6-C12 aryloxy groups.
23. Resin-extended modified diene elastomer according to any one of the preceding embodiments, wherein the modifying agent corresponds to the following formula (I)

Z(R₂)ₚ(T)ᵣ(R₃—Y)_{q} (I)

in which:
Z represents an atom selected from the group consisting of Si, Sn and P;
T represents a halogen atom or an OR₄ radical with R₄ a C1-C10 alkyl or a C6-C12 aryl;
R₂ represents, independently at each occurrence, a C1-C10 alkyl, preferably C1-C4 alkyl;
R₃ represents a saturated or unsaturated, cyclic or non-cyclic, divalent C1-C18 aliphatic hydrocarbon radical, or a divalent C6-C18 aromatic hydrocarbon radical; preferably a C1-C10 alkanediyl;
Y is a hydrogen atom or a function capable of interacting with a reinforcing filler;
p represents an integer equal to 0, 1 or 2;
q represents an integer equal to 0 or 1;
r represents an integer equal to 2, 3 or 4; and
   with the proviso that:
when Z is P then q is equal to 0, p is equal to 0 or 1 and r+p=3;
when Z is Sn then q is equal to 0 and r+p=4;
when Z is Si then r+p+q=4.
24. Resin-extended modified diene elastomer according to Embodiment 23, wherein in formula (I) the halogen is selected from the group consisting of fluorine, chlorine, bromine and iodine; preferably is chlorine.
25. Resin-extended modified diene elastomer according to Embodiments 23 or 24, wherein, in formula (I), R₄, independently at each occurrence, represents a C1-C8 alkyl or a C6-C12 aryl, more preferentially a C1-C4 alkyl or a C6 aryl; more preferentially still R₄, independently at each occurrence, represents a methyl, an ethyl or a phenyl that is unsubstituted or substituted by one or more C1-C6 alkyls, more preferentially still R₄, independently at each occurrence, represents a methyl, an ethyl or a phenyl that is unsubstituted or substituted by one or more t-butyl groups.
26. Resin-extended modified diene elastomer according to any one of Embodiments 23 to 25, wherein, in formula (I), R₂, independently at each occurrence, represents a methyl, an ethyl or a propyl.
27. Resin-extended modified diene elastomer according to any one of Embodiments 23 to 26, wherein, in formula (I), R₃ is a C1-C10 alkanediyl, more preferentially a C1-C6 alkanediyl, more preferentially still propanediyl.
28. Resin-extended modified diene elastomer according to any one of Embodiments 23 to 27, wherein, in formula (I), the function capable of interacting with the reinforcing filler comprises at least one heteroatom selected from nitrogen, sulfur, oxygen and phosphorus.
29. Resin-extended modified diene elastomer according to any one of Embodiments 23 to 28, wherein, in formula (I), the function capable of interacting with the reinforcing filler is a function selected from the group consisting of primary, secondary or tertiary amines, isocyanates, imines, cyanos, thiols, carboxylates, epoxides and primary, secondary or tertiary phosphines.
30. Resin-extended modified diene elastomer according to any one of Embodiments 23 to 29, wherein, in formula (I), the function capable of interacting with the reinforcing filler is a function selected from the group consisting of primary, secondary or tertiary amines.
31. Resin-extended modified diene elastomer according to any one of Embodiments 23 to 27, wherein in formula (I) q is equal to 0.
32. Resin-extended modified diene elastomer according to any one of Embodiments 23 to 27, wherein in formula (I) q is equal to 0; Z represents an atom selected from the group consisting of Sn and P; T represents a halogen atom or an OR₄ radical with R₄ a C1-C10 alkyl or a C6 aryl; R₂ represents, independently at each occurrence, a C1-C10 alkyl, preferably C1-C4 alkyl; p represents an integer equal to 0, 1 or 2; r represents an integer equal to 2, 3 or 4; and with the proviso that when
   when Z is P then r+p=3;
   when Z is Sn then r+p=4.
33. Resin-extended modified diene elastomer according to any one of Embodiments 23 to 27, wherein in formula (I) q is equal to 0; Z represents a phosphorus atom; T represents a halogen atom or an OR₄ radical with R₄ a C1-C10 alkyl or a C6 aryl; R₂ represents, independently at each occurrence, a C1-C10 alkyl, preferably C1-C4 alkyl; p represents an integer equal to 0 or 1; r represents an integer equal to 2 or 3 and r+p=3.
34. Resin-extended modified diene elastomer according to any one of Embodiments 23 to 30, wherein in formula (I) q is equal to 1.
35. Resin-extended modified diene elastomer according to any one of Embodiments 23 to 30, wherein in formula (I) q is an integer equal to 1; Z represents a silicon atom; T represents a halogen atom or an OR₄ radical with R₄ a C1-C10 alkyl; R₂ represents, independently at each occurrence, a C1-C10 alkyl, preferably C1-C4 alkyl; R₃ represents a saturated or unsaturated, cyclic or non-cyclic, divalent C1-C18 aliphatic hydrocarbon radical, or a divalent C6-C18 aromatic hydrocarbon radical, preferably a C1-C10 alkanediyl; Y is a hydrogen atom or a function capable of interacting with a reinforcing filler; p represents an integer equal to 0, 1 or 2; r represents an integer equal to 2, 3 or 4; and r+p+q=4.
36. Resin-extended modified diene elastomer according to any one of Embodiments 23 to 30, wherein in formula (I) q is an integer equal to 1; Z represents a silicon atom; T represents a halogen atom or an OR₄ radical with R₄ a C1-C4 alkyl; R₂ represents, independently at each occurrence, a C1-C4 alkyl, preferably methyl or ethyl; R₃ represents a C1-C6 alkanediyl, more preferentially propanediyl; Y an amine function; p represents an integer equal to 0, 1 or 2; r represents an integer equal to 2, 3 or 4; and r+p+q=4.
37. Rubber composition based on at least one resin-extended modified diene elastomer defined according to any one of the preceding Embodiments 1 to 36, a reinforcing filler and a crosslinking system.
38. Composition according to Embodiment 37, wherein the reinforcing filler comprises an inorganic reinforcing filler, preferentially comprises a silica.
39. Semi-finished rubber article for a tyre comprising at least one crosslinkable or crosslinked composition according to Embodiment 37 or 38, the semi-finished article preferably being a tread.
40. Tyre comprising at least one rubber composition defined according to Embodiment 37 or 38 or a semi-finished article defined according to Embodiment 39.

The abovementioned characteristics of the present invention, and also others, will be better understood on reading the following description of several exemplary embodiments of the invention, which are given as nonlimiting illustrations.

### Examples

Examples of Preparation of the Elastomers

The characteristics of the elastomers, resins, oils and compositions are determined according to the methods described above.

Preparation of the Polymer A: Resin-Extended Unmodified Functional SBR—Control

A continuously fed, 32.5 litre reactor, which is assumed to be perfectly stirred according to those skilled in the art, is continuously charged with methylcyclohexane at a mass flow rate of 51.5 kg·h⁻¹, with butadiene at a mass flow rate of 6.34 kg·h⁻¹, with styrene at a mass flow rate of 0.2 kg·h⁻¹ and 18 ppm of tetrahydrofurfuryl ethyl ether. The concentration by mass of monomer is equal to 11% by weight (ppm=part per million).

n-Butyllithium (n-BuLi) is introduced in a sufficient amount in order to neutralize the protic impurities introduced by the different constituents present in the reactor input.

1060 μmol of n-BuLi per 100 g of monomers are introduced at the inlet of the reactor.

The different flow rates are calculated in order for the mean residence time in the reactor to be 25 min. The temperature is maintained at 95° C.

A sample of polymer solution is withdrawn at the outlet of the polymerization reactor. The polymer thus obtained is subjected to an antioxidizing treatment with addition of 0.4 phr of 2,2′-methylenebis(4-methyl-6-(tert-butyl)phenol) and 0.2 phr of N-(1,3-dimethylbutyl)-N′-phenyl-p-phenylenediamine.

The degree of conversion obtained at this step is 97% by weight. It is determined by dry extract at 140° C. under reduced pressure of 200 mmHg. The polymer thus treated is subsequently separated from its solution by a steam stripping operation and then dried on an open mill at 100 C. The characteristics of the polymer obtained at this step, that is to say the initial inherent viscosity, the initial Mn, the initial Mw and the initial PDI (PDI=polydispersity index) and its glass transition temperature, are given in Table 2.

At the outlet of the polymerization reactor, at a temperature equal to 95° C., 575 μmol of hexamethylcyclotrisiloxane in solution in methylcyclohexane per 100 g of monomers are added to the living polymer solution (hexamethylcyclotrisiloxane/lithium molar ratio=0.54). The mixing is carried out in a static mixer of SMX type consisting of 20 elements followed by tubing for a residence time of at least 2.5 minutes.

The polymer thus obtained is subjected to an antioxidizing treatment with addition of 0.4 phr of 2,2′-methylenebis(4-methyl-6-(tert-butyl)phenol) and 0.2 phr of N-(1,3-dimethylbutyl)-N′-phenyl-p-phenylenediamine. A homogeneous solution of unmodified functionalized copolymer of styrene and butadiene is obtained. Subsequently, a solution prepared from Escorez 5600 resin from Exxon at 70% by weight in methylcyclohexane is added to the elastomeric solution in an amount of 53 parts per 100 parts by weight of elastomer. Mixing is carried out in a static mixer consisting of 36 mixing elements of Kenics KMR type.

The mixture of unmodified diene elastomer/resin in methylcyclohexane is then separated from the methylcyclohexane by a steam stripping operation, and then dried on an open mill at 100° C.

The characteristics of the resin-extended unmodified polymer A obtained at this step, that is to say the final inherent viscosity, the final Mn, the final Mw and the final PDI, are given in Table 2.

Preparation of the Polymer B: Resin-Extended Unmodified Functional SBR—Control

The procedure used to prepare polymer A is followed for obtaining polymer B, except for the amounts of each of the components which are modified. These amounts are mentioned in Table 1.

The characteristics of the resin-extended unmodified polymer B obtained are given in Table 2.

Preparation of the Polymer C: Resin-Extended Modified Functional SBR—According to the Invention A continuously fed, stirred 550 litre reactor is continuously charged with methylcyclohexane at a mass flow rate of 623.4 kg·h⁻¹, with butadiene at a mass flow rate of 74.7 kg·h⁻¹, with styrene at a mass flow rate of 1.7 kg·h⁻¹ and 17 ppm of tetrahydrofurfuryl ethyl ether. The concentration by mass of monomer is equal to 11 by weight.

n-Butyllithium (n-BuLi) is introduced in a sufficient amount in order to neutralize the protic impurities introduced by the different constituents present.

576 μmol of n-BuLi per 100 g of monomers are introduced at the inlet of the reactor.

The different flow rates are calculated in order for the mean residence time in the reactor to be 35 min. The temperature is maintained at 95° C.

A sample of polymer solution is withdrawn at the outlet of the polymerization reactor. The polymer thus obtained is subjected to an antioxidizing treatment with addition of 0.4 phr of 2,2′-methylenebis(4-methyl-6-(tert-butyl)phenol) and 0.2 phr of N-(1,3-dimethylbutyl)-N′-phenyl-p-phenylenediamine.

The degree of conversion obtained at this step is 95% by weight. It is determined by dry extract at 140° C. under reduced pressure of 200 mmHg. The polymer thus treated is subsequently separated from its solution by a steam stripping operation and then dried on an open mill at 100 C. The characteristics of the polymer obtained at this step, that is to say the initial inherent viscosity, the initial Mn, the initial Mw, the initial PDI and its glass transition temperature, are given in Table 2.

At the outlet of the polymerization reactor, at a temperature equal to 95° C., 310 μmol of (N,N-dimethylaminopropyl)trimethoxysilane in solution in methylcyclohexane per 100 g of monomers ((N,N-dimethylaminopropyl)trimethoxysilane/lithium molar ratio=0.54) are added to the living polymer solution. The mixing is carried out in a static mixer of SMX type consisting of 20 elements followed by tubing for a residence time of at least 2.5 minutes.

The polymer thus obtained is subjected to an antioxidizing treatment with addition of 0.6 phr of 2,2′-methylenebis(4-methyl-6-(tert-butyl)phenol) and 0.2 phr of N-(1,3-dimethylbutyl)-N′-phenyl-p-phenylenediamine. A homogeneous solution of functionalized and modified copolymer of styrene and butadiene is obtained. Subsequently, a solution prepared from Escorez 5600 resin from Exxon at 70% by weight in methylcyclohexane is added to the elastomeric solution in an amount of 51 parts per 100 parts by weight of elastomer.

The mixture of modified diene elastomer/resin in methylcyclohexane is then separated from the methylcyclohexane by a steam stripping operation, and then dried on an open mill at 100° C.

The characteristics of the resin-extended modified polymer C obtained at this step, that is to say the final inherent viscosity, the final Mn, the final Mw and the final PDI, are given in Table 2.

Preparation of the Polymer D: Resin-Extended Modified Non-Functionalized SBR—According to the Invention

The procedure used to prepare polymer C is followed for preparing polymer D, except for the natures and/or amounts of each of the components, the details of which are available in Table 1.

The characteristics of the resin-extended modified polymer D obtained at this step, that is to say the final inherent viscosity, the final Mn, the final Mw and the final PDI, are given in Table 2.

TABLE 1
Comparison of polymerization conditions

| | | | According | According |
|---|---|---|---|---|
| | | | to the | to the |
| | Control | Control | invention | invention |
| Polymer name | A | B | C | D |
| Methylcyclohexane | 51.5 | 43.4 | 623.4 | 43.0 |
| (kg · h⁻¹) | | | | |
| Butadiene (kg · h⁻¹) | 6.34 | 5.27 | 74.7 | 5.28 |
| Styrene (kg · h⁻¹) | 0.20 | 0.17 | 1.70 | 0.16 |
| Monomer concentration | 11 | 11 | 11 | 11 |
| by mass (% by weight) | | | | |
| Tetrahydrofurfuryl | 18 | 12 | 17 | 12 |
| ethyl ether (ppm) | | | | |
| n-butyllithium (μmcm) | 1060 | 587 | 576 | 593 |
| Residence time (min) | 25 | 30 | 35 | 30 |
| Polymerization | 95 | 95 | 95 | 95 |
| temperature (° C.) | | | | |
| Hexamethylcyclotrisiloxane | 575 | 205 | (—) | (—) |
| (μmcm) | | | | |
| N,N- | (—) | (—) | 310 | (—) |
| (dimethylaminopropyl) | | | | |
| trimethoxysilane | | | | |
| (μmcm) | | | | |
| Tris(2,4-di(tert- | (—) | (—) | (—) | 162 |
| butyl)phenyl) phosphite | | | | |
| (μmcm) | | | | |
| Antioxidant* | 0.4/0.2 | 0.4/0.2 | 0.6/0.2 | 0.6/0.2 |
| Injected resin (phr) | 53 | 56 | 51 | 46 |

*Antioxidant: 2,2′-methylenebis(4-methyl-6-(tert-butyl)phenol) (phr)/N-(1,3-dimethylbutyl)-N′-phenyl-p-phenylenediamine (phr)

TABLE 2
Comparison of elastomer characteristics

| | | | According | According |
|---|---|---|---|---|
| | | | to the | to the |
| | Control | Control | invention | invention |
| Polymer name | A | B | C | D |
| Conversion (wt %) | 97 | 97 | 95 | 96 |
| initial viscosity (dl/g) | 1.82 | 2.53 | 2.56 | 2.45 |
| final viscosity (dl/g) | 1.81 | 2.53 | 3.16 | 3.40 |
| Final/initial viscosity | 0.99 | 1.00 | 1.25 | 1.39 |
| styrene %/SBR | 2.5 | 2.5 | 2.2 | 2.6 |
| vinyl %/BR | 13.3 | 13.2 | 13.0 | 12.9 |
| Tg polymer (° C.) ⁽¹⁾ | −87.80 | −87.94 | −88.20 | −87.80 |
| Initial Mn (g/mol) Mn1 | 115 600 | 167 100 | 161 167 | 157 778 |
| Initial Mw (g/mol) Mw1 | 186 400 | 281 600 | 290 100 | 284 000 |
| initial PDI | 1.61 | 1.68 | 1.80 | 1.80 |
| Injected resin content (phr) | 53 | 56 | 50 | 46 |
| final Mn (g/mol) Mn2 | 115 600 | 167 100 | 254 450 | 279 000 |
| final Mw (g/mol) Mw2 | 186 400 | 281 600 | 405 850 | 467 500 |
| final PDI (Mw/Mn) | 1.61 | 1.69 | 1.60 | 1.68 |
| Mn2/Mn1 Final Mn/initial Mn | 1.00 | 1.00 | 1.58 | 1.77 |

⁽¹⁾ The Tg of the polymer is measured before the addition of the resin according to the standard ASTM D3418-08.

Example of Preparation of the Rubber Compositions

The elastomers A to F were used to prepare rubber compositions of tread type, each comprising silica as reinforcing filler.

The formulations are expressed as percentage by weight per 100 parts by weight of elastomer (phr) and are presented in Table 3.

TABLE 3

| | C1 | C2 | I1 | I2 |
|---|---|---|---|---|
| Polymer A | 153 | | | |
| Polymer B | | 156 | | |
| Polymer C | | | 151 | |
| Polymer D | | | | 146 |
| Silica (1) | 145 | 145 | 145 | 145 |
| Coupling agent (2) | 11.6 | 11.6 | 11.6 | 11.6 |
| Carbon black (3) | 7 | 7 | 7 | 7 |
| Plasticizing resin (4) | 56 | 53 | 58 | 63 |
| Oil (5) | 12 | 12 | 12 | 12 |
| ZnO | 3 | 3 | 3 | 3 |
| Stearic acid | 2 | 2 | 2 | 2 |
| Antioxidant (6) | 2 | 2 | 2 | 2 |
| Diphenylguanidine (7) | 2.2 | 2.2 | 2.2 | 2.2 |
| Sulfur | 1.8 | 1.8 | 1.8 | 1.8 |
| Sulfenamide (8) | 2.7 | 2.7 | 2.7 | 2.7 |

(1) Zeosil 1165 MP highly dispersible silica sold by Solvay having a BET specific surface area of 160 m²/g and CTAB specific surface area of 155 m²/g
(2) Agent for coupling silica with the elastomer: bis[3-(triethoxysilyl)propyl]tetrasulfide silane (TESPT) sold by Evonik under the reference Si69
(3) ASTM N234 grade carbon black sold by Cabot Corporation
(4) Plasticizing resin sold by Exxon Mobil under the reference Escorez 5600, Tg = 55° C. measured in accordance with the standard ASTM D3418-08 and Mn = 500 g/mol measured according to the SEC-RI method described above.
(5) TDAE oil: TDAE oil sold by the Klaus Dahleke under the reference 3VIVATEC500
(6) N-(1,3-dimethylbutyl)-N′-phenyl-p-phenylenediamine sold by Flexys under the reference Santoflex 6-PPD
(7) DPG sold by Flexys under the reference Perkacit
(8) N-cyclohexyl-2-benzothiazolesulfenamide sold by Flexys under the reference Santocure CBS

All the compositions have, in the end, the same resin content, namely 109 phr.

Each of the compositions is produced, in a first step, by thermomechanical working and then, in a second finishing step, by mechanical working.

The elastomer, resin-extended or otherwise, two-thirds of the amount of silica, the coupling agent, the diphenylguanidine and the carbon black are introduced into a laboratory internal mixer of “Banbury” type which has a capacity of 400 cm³, which is 72% filled and which has an initial temperature of 90° C.

The thermomechanical working is carried out by means of blades, the mean speed of which is 50 rpm and the temperature of which is 90° C.

After one minute, the final third of the amount of silica, the antioxidant, the stearic acid, the TDAE oil and the plasticizing resin are introduced, still under thermomechanical working.

After two minutes, the zinc oxide is introduced, the speed of the blades being 50 rpm. The thermomechanical working is carried out for a further two minutes, up to a maximum dropping temperature of approximately 160° C.

The mixture thus obtained is recovered and cooled and then, in an external mixer (homofinisher), the sulfur and the sulfenamide are added at 30° C., the combined mixture being further mixed for a time of 3 to 4 minutes (second step of mechanical working).

The compositions thus obtained are subsequently calendered, either in the form of slabs (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tyres, in particular as treads.

Crosslinking is carried out at 150° C. for 40 min.

The results of the mechanical properties of the compositions are presented in Table 4 along with the quality of extrusion thereof.

TABLE 4

| Composition | C1 | C2 | I1 | I2 |
|---|---|---|---|---|
| Polymer | A | B | C | D |
| Tan δ max 23° C. (in base | 100 | 105 | 100 | 100 |
| 100) | | | | |
| Tack index (base 100) | 100 | 52 | 32 | 34 |
| Garvey rating (edge) | 9 | 7 | 6 | 7 |
| Garvey rating (surface) | A | A | A | A |

When the number-average molar mass of a resin-extended unmodified elastomer is increased, a reduction in the tackiness of the composition comprising such an elastomer (control composition C2) is observed compared with the control composition C1.

Surprisingly, when the number-average molar mass of a resin-extended elastomer continues to be increased by modifying this elastomer with the aid of a modifying agent in order to obtain a resin-extended modified diene elastomer comprising branched chains, a very significant reduction in the tackiness of the compositions containing such elastomers (compositions I1 and I2 according to the invention) is observed. It is noted that this reduction in tackiness of the compositions of the invention does not negatively affect the quality of the extrudate which retains an excellent surface rating and a good edge rating.

Surprisingly and in contrast to what is observed for the control composition C2, this reduction in tackiness of these compositions I1 and I2 is not detrimental to the hysteresis, which is at a comparable level to that of the control composition C1. Thus, for the compositions I1 and I2 according to the invention, the rolling resistance and processability performance compromise is improved compared with that of the control compositions C1 and C2 without the extrusion quality being negatively affected.

1.-15. (canceled)

16. A resin-extended modified diene elastomer capable of being obtained by a process comprising at least:
a step of anionically polymerizing, in an organic solvent, at least one conjugated diene monomer having from 4 to 12 carbon atoms in the presence of a polymerization initiator to form a living diene elastomer having a number-average molar mass Mn1 measured by triple detection size exclusion chromatography;
a step of modifying the living diene elastomer of number-average molar mass Mn1, in the organic solvent, by reaction with a modifying agent to form a modified diene elastomer having a number-average molar mass Mn2 measured by triple detection size exclusion chromatography and a glass transition temperature, measured according to the standard ASTM D3418-08, within a range extending from −95° C. to −70° C.;
a step of adding at least one plasticizing resin to the organic solvent comprising the modified diene elastomer; and
a step of removing the organic solvent to obtain the resin-extended modified diene elastomer,
wherein the resin-extended modified diene elastomer has an Mn2/Mn1 ratio of strictly greater than 1.00 and an Mn2 of greater than or equal to 200,000 g/mol.

17. The resin-extended modified diene elastomer according to claim 16, wherein the number-average molar mass Mn2 is greater than or equal to 220,000 g/mol.

18. The resin-extended modified diene elastomer according to claim 16, wherein the Mn2/Mn1 ratio is greater than or equal to 1.10.

19. The resin-extended modified diene elastomer according to claim 16, wherein the modifying agent comprises at least one atom bearing at least two functions reactive with the living diene elastomer, the at least one atom being selected from the group consisting of a silicon atom, a phosphorus atom and a tin atom.

20. The resin-extended modified diene elastomer according to claim 19, wherein the at least two functions reactive with the living diene elastomer, which may be identical or different, are selected from the group consisting of halogen atoms, C1-C10 alkoxy groups and C6-C12 aryloxy groups.

21. The resin-extended modified diene elastomer according to claim 16, wherein the modifying agent corresponds to the following formula (I):
Z(R₂)ₚ(T)ᵣ(R³—Y)_{q} (I),
in which:
Z represents an atom selected from the group consisting of Si, Sn and P;
T represents a halogen atom or an OR₄ radical with R₄ being a C1-C10 alkyl or a C6-C12 aryl;
R₂ represents, independently at each occurrence, a C1-C10 alkyl;
R³ represents a saturated or unsaturated, cyclic or non-cyclic, divalent C1-C18 aliphatic hydrocarbon radical, or a divalent C6-C18 aromatic hydrocarbon radical;
Y is a hydrogen atom or a function capable of interacting with a reinforcing filler;
p represents an integer equal to 0, 1 or 2;
q represents an integer having the value 0 or 1; and
r represents an integer having the value 2, 3 or 4;
with the proviso that
when Z is P then q is equal to 0, p is equal to 0 or 1 and r+p=3,
when Z is Sn then q is equal to 0 and r+p=4, and
when Z is Si then r+p+q=4.

22. The resin-extended modified diene elastomer according to claim 21, wherein the function capable of interacting with the reinforcing filler is function selected from the group consisting of primary, secondary or tertiary amines, isocyanates, imines, cyanos, thiols, carboxylates, epoxides or primary, secondary or tertiary phosphines.

23. The resin-extended modified diene elastomer according to claim 16, wherein q=0.

24. The resin-extended modified diene elastomer according to claim 16, wherein the step of anionic polymerization is carried out additionally in the presence of at least one vinylaromatic monomer having from 8 to 20 carbon atoms.

25. The resin-extended modified diene elastomer according to claim 16, wherein the plasticizing resin is selected from the group consisting of aliphatic resins, aromatic resins and mixtures thereof.

26. The resin-extended modified diene elastomer according to claim 16, wherein the plasticizing resin has a number-average molar mass of between 400 and 2000 g/mol.

27. The resin-extended modified diene elastomer according to claim 16, wherein a content of plasticizing resin is within a range extending from 5 to 100 phr.

28. A rubber composition based on at least one resin-extended modified diene elastomer according to claim 16, a reinforcing filler and a crosslinking system.

29. A semi-finished rubber article for a tire comprising at least one crosslinkable or crosslinked rubber composition according to claim 28.

30. A tire comprising at least one rubber composition according to claim 28.

31. A tire comprising at least one semi-finished rubber article according to claim 29.
